(19) United States
(12) Patent Application Publication
(10) Pub. No.: US 2022/0306523 A1
(43) Pub. Date: Sep. 29, 2022

(54) GLASS ARTICLE WITH A LIVING HINGE

(71) Applicant: Corning Incorporated, Corning, NY (US)

(72) Inventors: Madeline Louraine Horn, Corning, NY (US); Christina Marie Laskowski, Painted Post, NY (US)

(21) Appl. No.: 17/606,900

(22) PCT Filed: Apr. 28, 2020
(86) PCT No.: PCT/US2020/030198

§ 371 Date: Oct. 27, 2021

Related U.S. Application Data
(60) Provisional application No. 62/842,860, filed on May 3, 2019.

(51) Int. Cl. C03C 15/00; E05D 1/02; C03C 17/00; C03B 23/023

(52) U.S. Cl. CPC C03C 15/00; E05D 1/02; C03C 17/002; C03B 23/023; C03C 2218/34; C03C 2218/33; E05Y 2800/672

(57) ABSTRACT

Disclosed herein are glass articles and methods of manufacturing the same. The glass articles may include a glass layer comprising a first portion having a first thickness, a second portion having a second thickness, and a third portion disposed in between the first portion and the second portion. The third portion may form a living hinge. The living hinge may comprise a plurality of indentations such that a majority of the third portion has a third thickness that is less than the first thickness and the second thickness. In addition, the living hinge may comprise a plurality of protrusions such that a majority of the third portion has a third thickness that is greater than the first thickness and the second thickness.

### CROSS-REFERENCE TO RELATED APPLICATIONS

This application claims the benefit of priority under 35 U.S.C. § 119 of U.S. Provisional Application Ser. No. 62/842,860 filed on May 3, 2019 the content of which is relied upon and incorporated herein by reference in its entirety.

### BACKGROUND

Generally speaking, glass is a nonpliable material at room temperatures. Therefore, bending glass panels to form curves or other non-planar structures requires the glass to be heated. Heating glass is an energy intensive process that requires a lot of resources so that glass becomes pliable. A way to bend glass so as to form curved or otherwise contoured surfaces at room temperature is therefore needed.

### SUMMARY

Disclosed herein are glass articles and methods of manufacturing the same. The glass articles may include a glass layer comprising a first portion having a first thickness, a second portion having a second thickness, and a third portion disposed in between the first portion and the second portion. The third portion may form a living hinge. The living hinge may comprise a plurality of indentations such that a majority of the third portion has a third thickness that is less than the first thickness and the second thickness. In addition, the living hinge may comprise a plurality of protrusions such that a majority of the third portion has a third thickness that is greater than the first thickness and the second thickness.

### BRIEF DESCRIPTION OF THE FIGURES

The drawings illustrate generally, by way of example, but not by way of limitation, various embodiments discussed herein.

FIGS. 1A, 1B, 1C, and 1D show a glass panel consistent with example embodiments disclosed herein.

FIGS. 2A and 2B show a glass panel consistent with example embodiments disclosed herein.

FIG. 3 shows a method consistent with example embodiments disclosed herein.

FIGS. 4A, 4B, 4C, and 4D show a glass panel consistent with example embodiments disclosed herein.

FIGS. 5A and 5B show a glass panel consistent with example embodiments disclosed herein.

FIG. 6 shows a method consistent with example embodiments disclosed herein.

FIGS. 7A, 7B, 8A, 8B, 9A, and 9B show glass articles consistent with example embodiments disclosed herein.

FIGS. 10 and 11 show glass articles consistent with example embodiments disclosed herein.

Like reference numbers in the various figures indicate like elements. Some elements may be present in identical or equivalent multiples; in such cases only one or more representative elements may be designated by a reference numeral, but it will be understood that such reference numbers apply to all such identical elements. Unless otherwise indicated, all figures and drawings in this document are not to scale and are chosen for the purpose of illustrating different embodiments of the disclosure. In particular, the dimensions of the various components are depicted in illustrative terms only, and no relationship between the dimensions of the various components should be inferred from the drawings, unless so indicated. Although terms such as “top,” “bottom,” “upper,” “lower,” “under,” “over,” “front,” “back,” “up,” “down,” “first,” “second,” etc. may be used in this disclosure, it should be understood that those terms are used in their relative sense only unless otherwise noted.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

As disclosed herein, there is a need for flexible, durable glass products. The flexible nature of the glass products may allow for curved or contoured glass articles to be manufactured without the need to heat the glass to a red hot or nearly molten state. A potential method disclosed herein for addressing this need is flexible glass that can be curved either free formed or to match existing structures. For example, flexible glass panels may be bent using the articles and methods disclosed herein to conform to profiles of front panels, arm-rests, doors, steering wheels, etc. of automobiles. Curving glass structures may allow for a seamless and aesthetically pleasing customer experience inside the automobiles.

The articles and methods disclosed herein may permit greater use of geometric space. For example, a flat glass panel could not recede into an engine block, but curved glass could avoid the engine block. This is beneficial because glass (as opposed to bendable plastics or other materials) is more durable and luxurious. Therefore, the bendable glass articles disclosed herein may better satisfy original equipment manufacturers (OEM) requirements.

As disclosed herein, a method of creating a bendable glass panel may include forming an article of glass that utilizes a living hinge. For example, as disclosed herein, thick glass may be selectively thinned via etching, scraping, or other material removal processes to form one or more living hinges. In another example, thin glass may be selectively thickened via printing, coating, epoxy addition, lamination, or other material addition processes to form one or more living hinges. In yet another example, a single glass panel may be both thinned and thickened to form living hinges on a single glass article.

As disclosed herein, the geometry of the living hinges may be varied to suit the final product. For example, two sets of slits (e.g., parallel slits, perpendicular slits, non-parallel and non-orthogonal slits, etc.) may be used to create two-dimensional bending. As a result, using the articles and methods disclosed herein may allow for origami-like folding/unfolding techniques to be applied to glass articles.

The articles of glass and the methods disclosed herein may allow for the two and three-dimensional bending of glass. As a result, complex folds of glass may be able to be created. The articles and methods disclosed herein may also enable easy coating and flexible display application as well as shipping of flat glass, which is easier, safer, and cheaper than curved glass.

As disclosed herein, localized thinning via etching, coating, etc., may do less damage to the glass than removal of a larger area of glass. In addition, selective material removal may reduce material removal processing needs. For example, a tank of hydrofluoric acid (HF) may take longer to be contaminated and thus, need changing less often.

Printing on the glass may enable a plethora of potential geometries and coatings as disclosed herein. For example, print different coatings in different areas on the same piece of glass may be used to create multiple geometries. Smaller etching lines may reduce distortion when printing and bending/folding/unfolding. This may allow for better control of where force is applied as glass bends and of the geometry itself. This may also allow for the glass to self-reinforce or otherwise provide its own backstop when it hits an end of travel.

Disclosed herein are two methods for creating a living hinge that may allow glass panels to be bent into various curved and contoured shapes. The first method uses subtractive technologies and the second method uses additive technologies. Subtractive technologies may allow thin glass to be selectively thinned via etching, scraping, or other material removal processes. As an example, very thin parallel lines could be etched deeply into a thin glass product, thus allowing dynamic bending perpendicular to the grooves. In addition, by varying groove spacing and width one may enable preferential bending on the same sheet of glass. The resulting localized thinning (via etching, coating, etc.) does less damage, and potentially less distortion, on the glass than removal of a larger area. Also, selective material removal may reduce material removal processing needs.

Additive technologies may provide an additional fabrication method by allowing very thin glass to be selectively thickened via printing, coating, epoxy addition, lamination, or other material addition processes. As an example, glass having a thickness of about 0.01 mm to about 0.4 mm, such as FLEXCER™ or WILLOW™ glasses offered by Corning) could be selectively coated/printed to strengthen and rigidify areas of the glass except the desired bending areas. Printing upon the glass may enable a plethora of potential geometries and coatings just as with subtractive methods disclosed herein.

Additional benefits of both subtractive and additive methods disclosed herein may include complex folds of glass, easy coating and flexible display applications, reduction of shipping costs, potentially better control of where force, torque, and curvature are applied, and potentially a self-reinforcing backstop when a bend hits an end of travel.

As disclosed herein, geometries may also be varied to suit a final product. For example, two sets of slits (parallel, perpendicular, oblique, etc.) may be used to create two-dimensional bending, or enable origami-like folding/unfolding techniques to be used to bend and shape glass panels.

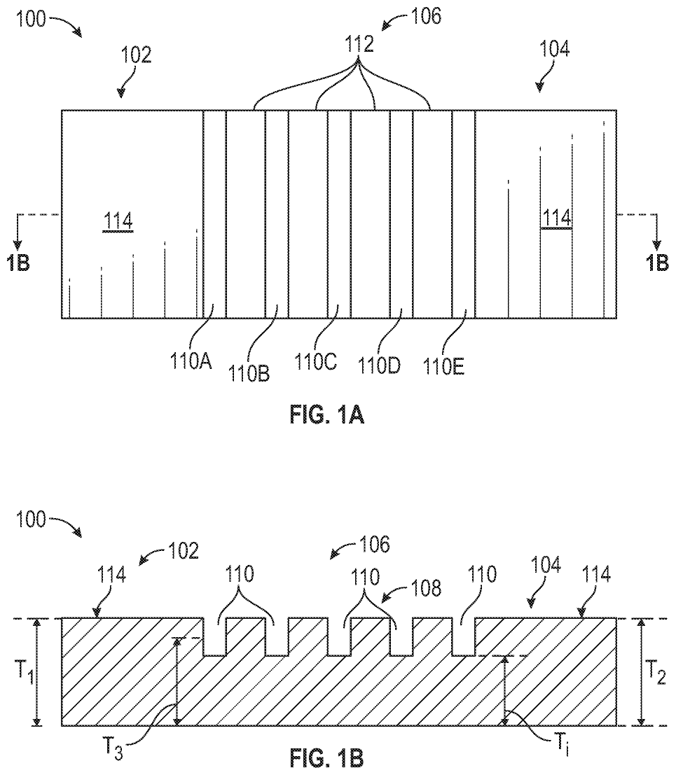

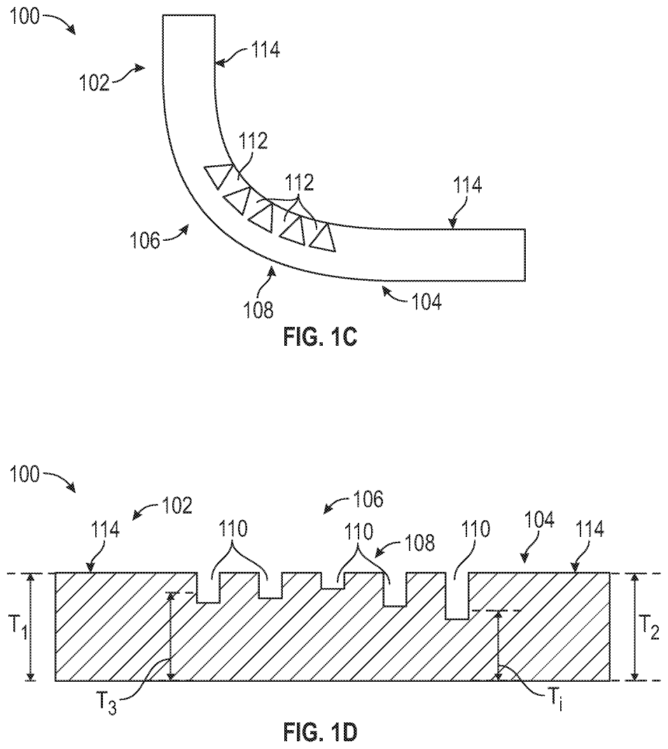

Turning now to the figures, FIGS. 1A, 1B, 1C, and 1D show a glass panel 100 consistent with example embodiments disclosed herein. Glass panel 100 may include a first portion 102, a second portion 104, and a third portion 106. First portion 102 may have a first thickness, T₁, and second portion 104 may have a second thickness, T₂. Third portion 106 may be disposed in between first portion 102 and second portion 104.

Third portion 106 may form a living hinge 108. Living hinge 108 may include a plurality of indentations 110. Each of the plurality of indentations 110 may have a thickness, Tᵢ. Tᵢ may be less than both of T₁ and T₂. As a result, an average thickness, T₃, for third portion 106 may be less than T₁ for first portion 102 and T₂ for second portion 104.

While FIG. 1B shows each of the plurality of indentations 100 having an equal Tᵢ, Tᵢ for each of the plurality of indentations 110, Tᵢ may be equal or may be different. For example, Ti for a first indentation 110A of the plurality of indentations 110 and Tᵢ for a fifth indentation 110E may be different. For instance, the thickness Tᵢ for each of first indentation 110A through fifth indentation 110E may incrementally decrease. Stated another way, Tᵢ for first indentation 110A, Tᵢ for second indentation 110B, Tᵢ for third indentation 110C, Tᵢ for fourth indentation 110D, and Tᵢ for fifth indentation 110E may all be different as shown in FIG. 1D or equal a shown in FIGS. 1A-1C.

As shown in FIG. 1C, each of the plurality of indentations 110 may allow tip portions 112 of a first surface 114 of glass panel 100 to contact one another so as to form a bend or other curved portion, such as third portion 106. Stated another way, the plurality of indentations 110 provide voids so that once the tip portions 112 are relocated out of a plane (as shown in FIG. 1B) formed by first surface 114, glass panel 100 may deform (as shown in FIG. 1C) so that glass panel 100 can be bent to form a curved surface, a non-planar surface, or other contoured surface.

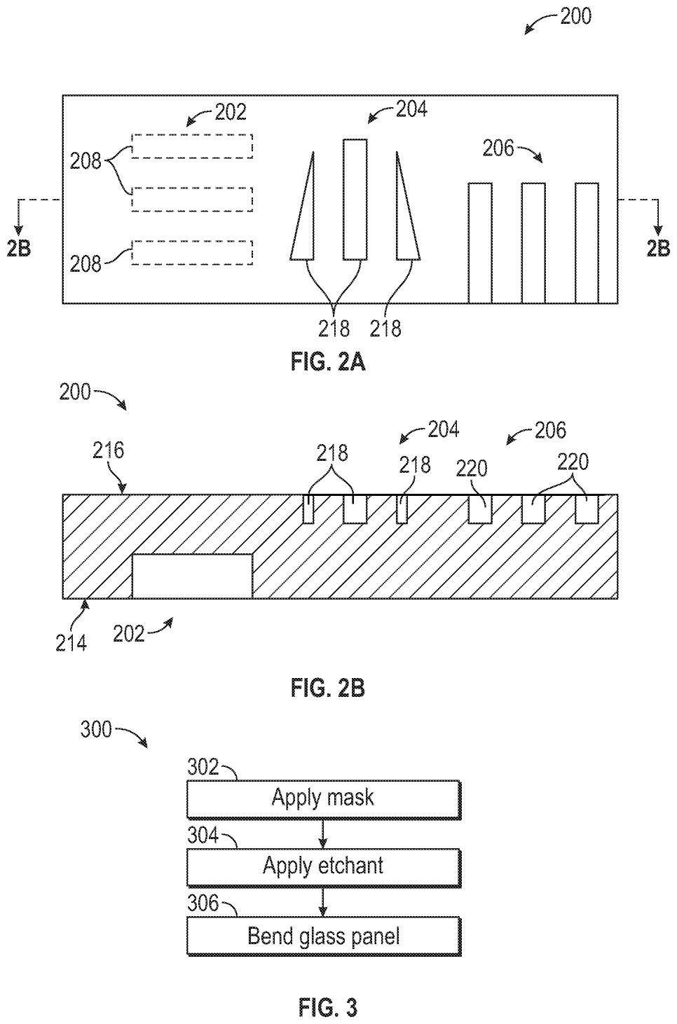

FIGS. 2A and 2B show a glass panel 200 consistent with example embodiment disclosed herein. As shown in FIGS. 2A and 2B, glass panel 200 may include a first living hinge 202, a second living hinge 204, and a third living hinge 206. First living hinge 202 may have a plurality of indentations 208 that are parallel to one another. In addition, first living hinge 202 may be located on a first surface 214 of glass panel 200.

Glass panel 200 may also have a second surface 216 that is located opposite first surface 214. Second living hinge 204 and third living hinge 206 may be located on second surface 216. As shown in FIG. 2B, second living hinge 204 may have a plurality of indentations 218 that are oblique to one another and oblique to the plurality of indentations 208. Third living hinge 206 may have a plurality of indentations 220 that are parallel to one another and perpendicular to the plurality of indentations 208 and oblique to the plurality of indentations 218.

While FIGS. 1A, 1B, 1C, 1D, 2A, and 2B show indentations extending partially through glass panels 100 and 200, various embodiments may include one or more indentations that extends completely through a glass panel. In addition, each of the living hinges shown in FIGS. 1A-2B show the indentations for respective living hinges on the same side of a glass panel, various embodiments may include one or more living hinges that includes one or more indentations on various surfaces or sides of a glass panel.

FIG. 3 shows a method 300 for forming a glass article consistent with example embodiments disclosed herein. Method 300 may include stage 302 where a mask may be applied to a glass panel. For example, various indentations may be needed to form one or more living hinges. To lay out the location for the various indentations, one or more masks that defines the size, number of indentation, and the location of the various indentations may be applied to one or more surfaces of the glass panel. For instance, a first mask may be applied to a first surface of a glass panel and the first mask may define a first plurality of shapes that correspond to a first living hinge as disclosed herein. A second mask may be applied to a second surface of a glass panel and the second mask may define a second plurality of shapes that correspond to a second living hinge as disclosed herein.

As disclosed herein, the one or more masks may define shapes for each of the indentations that may make up each of the one or more living hinges. As disclosed herein, the shapes may be triangular, rectangular, pentagonal, or any number of sided polygons. Still consistent with embodiments disclosed herein, the shapes may include straight shapes such as rectangles and non-straight shapes such as curves or other spline-based features.

The one or more masks may be applied via methods such as silk screening, printing technologies, etc. The one or more masks may be constructed of a material that does not react with the glass panel is inert with respect to an etchant.

Method 300 may also include stage 304 where an etchant may be applied to form the living hinge. For example, the etchant may be applied to the first surface of the glass panel to form a first plurality of indentations and each of the first plurality of indentations may have one of the first plurality of shapes defined by the first mask and a depth. The etchant may also be applied to the second surface of the glass panel to form a second plurality of indentations and each of the second plurality of indentations may have one of the second plurality of shapes defined by the second mask and a depth. As a result, applying the etchant may allow the various living hinges to be formed.

The etchant may be any substance that will etch glass. Examples of the etchant include HF, NaOH, etc. Applying the etchant may also including applying a neutralizer that stops the etchant from dissolving the glass panel after a given time. The given time may vary depending on the etchant used, the depth of the indentations, the chemical makeup of the glass, etc.

As disclosed herein, the glass panel may have a thickness that is greater than about 100 microns. For example, the glass panel may have an initial thickness that is about 300 microns. The etchant may be applied so that the indentations have a depth of about 200 microns. Stated another way, the etched may reduce the thickness of the glass panel to about 100 microns wherever the mask allows the etchant to contact the glass panel. The glass panel may be thinned to about 100 microns because at around 100 microns or less, a cold formed glass may become bendable or otherwise pliable.

Method 300 may further include stage 306 where the glass panel may be bent about one or more living hinges to form one or more curved or otherwise non-planar or contoured surfaces. For example, the glass panel may be bent about the first living hinge to form a first curved surface and the glass panel may be bent about the second living hinge to form a second curved surface.

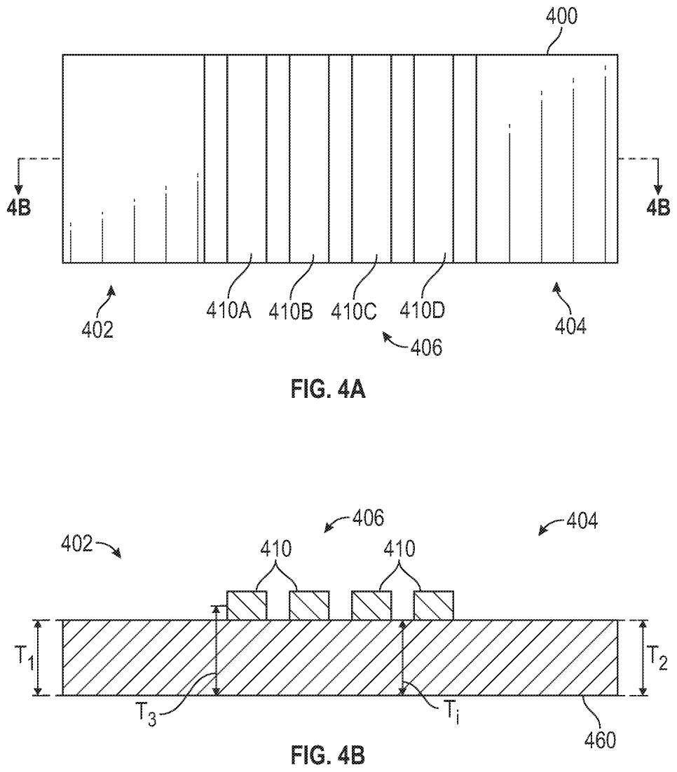

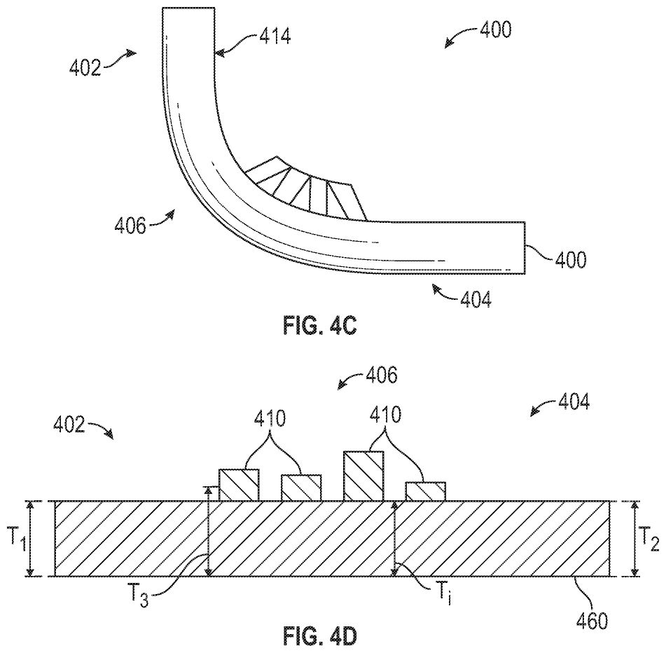

FIGS. 4A, 4B, 4C, and 4D show a glass panel 400 consistent with example embodiments disclosed herein. Glass panel 400 may include a first portion 402, a second portion 404, and a third portion 406. First portion 402 may have a first thickness, T₁, and second portion 404 may have a second thickness, T₂. Third portion 406 may be disposed in between first portion 402 and second portion 404.

Third portion 406 may form a living hinge 408. Living hinge 408 may include a plurality of protrusions 410. Each of the plurality of protrusions 410 may have a thickness, Tᵢ. Tᵢ may cause living hinge 408 to have an average thickness, T₃, that is greater than T₁ and T₂.

While FIG. 4B shows each of the plurality of protrusions 410 having an equal Tᵢ, Tᵢ for each of the plurality of protrusions 410, Tᵢ may be equal or may be different. For example, Ti for a first protrusion 410A of the plurality of protrusions 410 and Tᵢ for a fourth protrusion 410D may be different. For instance, the thickness Tᵢ for each of first protrusion 410A through fourth protrusion 410E may incrementally decrease. Stated another way, Tᵢ for first protrusion 410A, Tᵢ for second protrusion 410B, Tᵢ for third protrusion 410C, and Tᵢ for fourth protrusion 410D may all be different as shown in FIG. 4D or equal as shown in FIGS. 4A-4C.

As shown in FIG. 4C, each of the plurality of protrusions 410 may allow tip portions 412 of a first surface 414 of glass panel 400 to contact one another so as to form a bend or other curved portion, such as third portion 406. Stated another way, the plurality of protrusions 410 provide stops so that once the tip portions 412 are relocated, glass panel 100 can be bent to form a curved surface, a non-planar surface, or other contoured surface as shown in FIG. 4C.

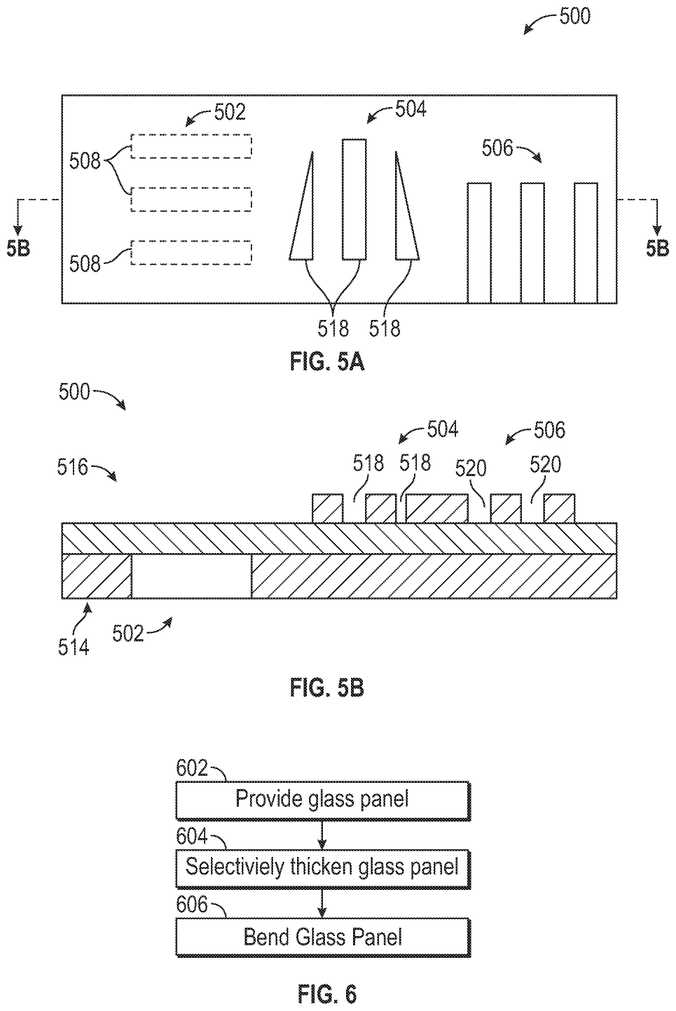

FIGS. 5A and 5B show a glass panel 500 consistent with example embodiment disclosed herein. As shown in FIGS. 5A and 5B, glass panel 500 may include a first living hinge 502, a second living hinge 504, and a third living hinge 506. First living hinge 502 may have a plurality of protrusions 508 that are parallel to one another. In addition, first living hinge 502 may be located on a first surface 514 of glass panel 500.

Glass panel 500 may also have a second surface 516 that is located opposite first surface 214. Second living hinge 504 and third living hinge 506 may be located on second surface 516. As shown in FIG. 5B, second living hinge 504 may have a plurality of protrusions 518 that are oblique to one another and oblique to the plurality of protrusions 508. Third living hinge 506 may have a plurality of protrusions 520 that are parallel to one another and perpendicular to the plurality of protrusions 508 and oblique to the plurality of protrusions 518.

While each of the living hinges shown in FIGS. 1A-5B show the protrusions for respective living hinges on the same side of a glass panel, various embodiments may include one or more living hinges that includes one or more protrusions on various surfaces or sides of a glass panel.

FIG. 6 shows a method 600 for forming a glass article consistent with example embodiments disclosed herein. Method 600 may include stage 602 where a glass panel may be provided. The glass panel may have a thickness of about 100 microns. At about 100 microns or less, the glass panel may be bendable or otherwise pliable.

Method 600 may include stage 604 where the glass panel may be thickened. For example, as disclosed herein one or more protrusions may be added to the glass panel to selectively thicken portions of the glass panel. For example, various protrusions may be attached to the glass panel to form one or more living hinges. For instance, a first set of protrusions may be added to a first surface of the glass panel and the first set of protrusions may define a first plurality of shapes that correspond to a first living hinge as disclosed herein. A second set of protrusions may be added to a second surface of a glass panel and the second set of protrusions may define a second plurality of shapes that correspond to a second living hinge as disclosed herein.

As disclosed herein, the one or more sets of protrusions may define shapes that may make up each of the one or more living hinges. As disclosed herein, the shapes or protrusions may be triangular, rectangular, pentagonal, or any number of sided polygons. Still consistent with embodiments disclosed herein, the shapes or protrusions may include straight shapes such as rectangles and non-straight shapes such as curves or other spline-based features.

The protrusions may be formed by bonding additional pieces of glass to the glass panel. In addition, the protrusions may be formed by building up layers of epoxy or other materials to selectively thicken the glass panel. For instance, additional pieces of glass may be bonded to the glass panel to selectively thicken the glass panel to a thickness greater than about 300 microns because at about 300 microns or greater, a cold formed glass may no longer be bendable. Thus, the portions of the glass panel that have been selectively thickened may not be bendable.

Method 300 may further include stage 606 where the glass panel may be bent about one or more living hinges to form one or more curved or otherwise non-planar or contoured surfaces. For example, the glass panel may be bent about the first living hinge to form a first curved surface and the glass panel may be bent about the second living hinge to form a second curved surface.

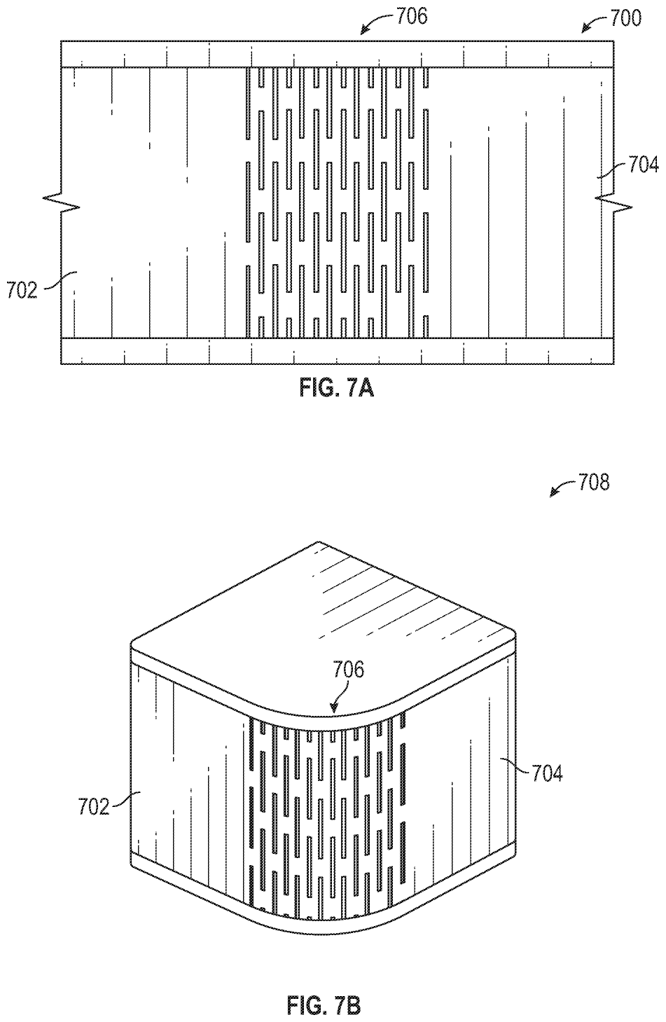

FIGS. 7A, 7B, 8A, 8B, 9A, and 9B shows glass articles consistent with example embodiments disclosed herein. FIGS. 7A and 7B show a glass panel 700 that includes a first portion 702, a second portion 704, and a third portion 706. Third portion 706 may include a plurality of indentations that are arranged parallel to one another to form a living hinge as disclosed herein. As shown in FIG. 7A, the plurality of indentations may be arranged parallel and offset to another. As shown in FIG. 7B, glass panel 700 may be bent in a direction that is opposite the direction the plurality of indentations face. FIGS. 1A-2B and 4A-5B show bends that occur on the same side of a glass panel as where the plurality of indentations is formed. Stated another way, the glass panels disclosed herein need not be bent in the direction that coincides with the surface or direction in which the plurality of indentations or protrusions is formed.

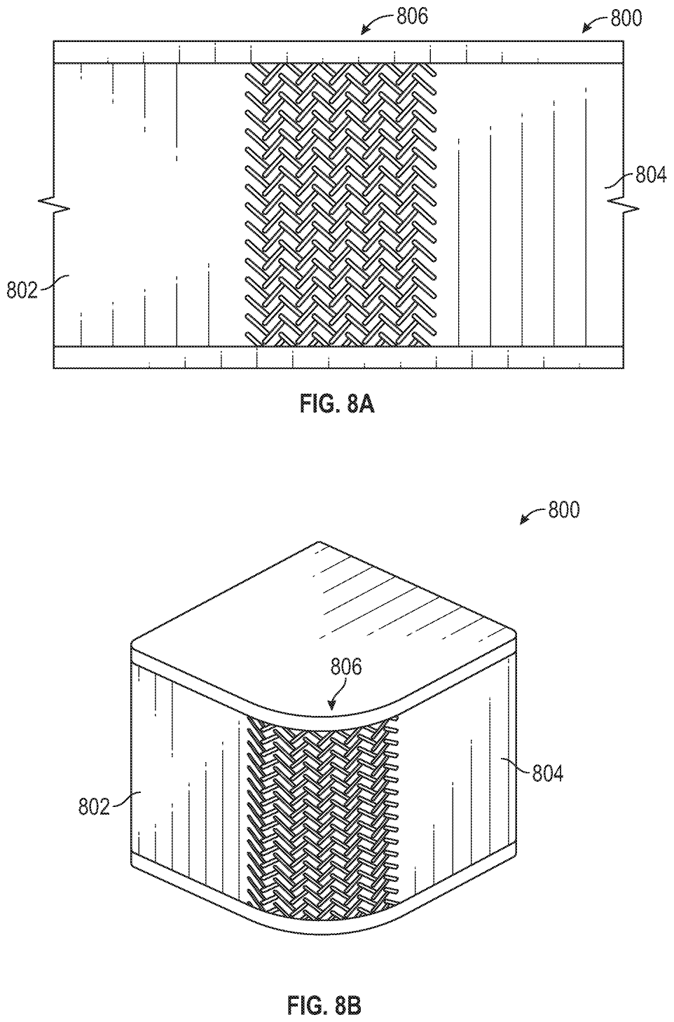

FIGS. 8A and 8B show a glass panel 800 that includes a first portion 802, a second portion 804, and a third portion 806. Third portion 806 may include a plurality of indentations that are arranged in a herringbone pattern to form a living hinge as disclosed herein. As shown in FIG. 8B, glass panel 800 may be bent in a direction that is opposite the direction the plurality of indentations face.

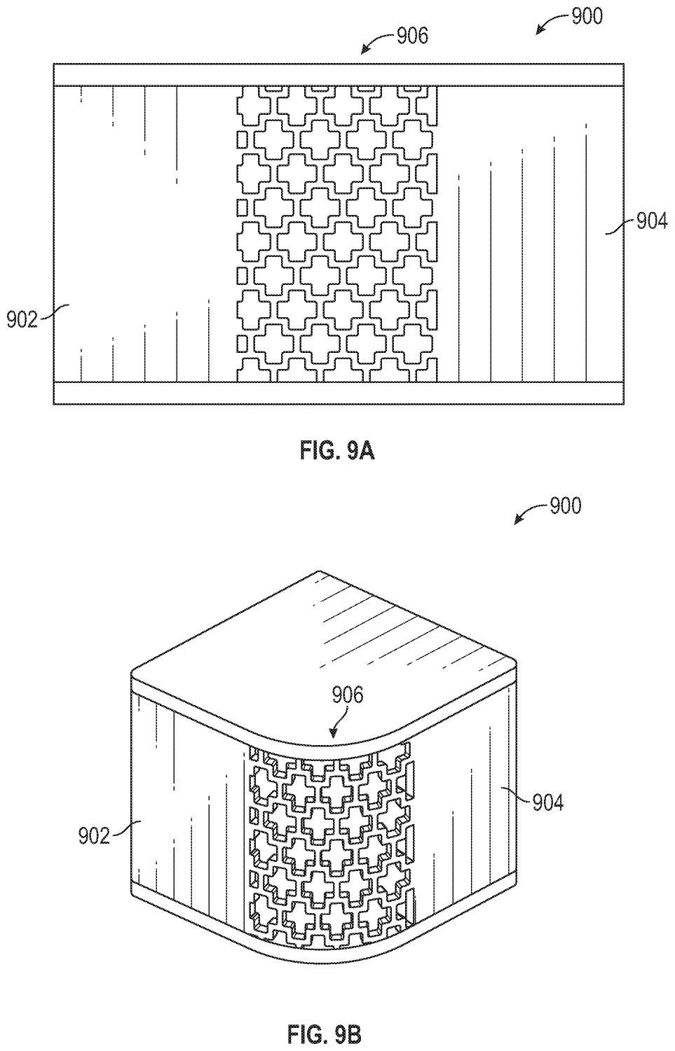

FIGS. 9A and 9B show a glass panel 900 that includes a first portion 902, a second portion 904, and a third portion 906. Third portion 906 may include a plurality of indentations that that are crossed shape and form a living hinge as disclosed herein. As shown in FIG. 9A, the plurality of indentations need not be a uniform rectangle or other regular polygonal shape. Instead, the plurality of indentation may be any shape. In addition, as shown in FIG. 8B, the plurality of indentations may pass through glass panel 900.

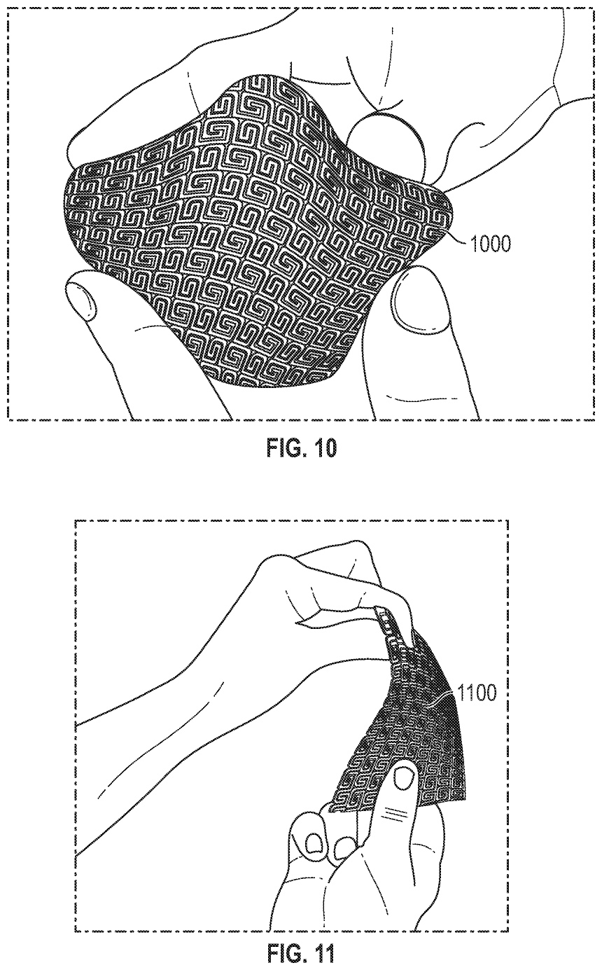

The living hinges and glass articles disclosed herein are not limited to bending along a single axis as shown in the above figures. FIGS. 10 and 11 each shows a glass article 1000 and 1100, respectively that is bent along multiple axes. As such, the living hinges and glass article disclosed herein are capable of forming complex geometries. The ability to bend cold form glass may allow for glass panels to be used in a variety of applications. One non-limiting use of the glass panels disclosed herein includes the automotive industry. For instance, glass may give a luxurious appears because it can be highly polished and have a nice shine. In addition, glass is easy to clean and stain resistant. Thus, using the glass panels disclosed herein, various components such as armrests, the dash, areas around a radio, etc. can include a glass overly to give a luxurious look that is both durable and easy to maintain.

While the apparatuses disclosed herein have been described with reference to glass structures, the living hinge concepts and methods for forming articles may also be used for materials such as ceramics (fused ceramics or otherwise), polymers, etc. For example, a thin ceramic that is about 10 microns to about 0.5 mm may include one or more living hinges as disclosed herein and be bent into desired contours and shapes as disclosed herein.

### EXAMPLES

The present disclosure provides for the following example embodiments, the numbering of which is not to be construed as designating levels of importance.

Example 1 is a glass article comprising: a glass layer comprising: a first portion having a first thickness, a second portion having a second thickness, and a third portion disposed in between the first portion and the second portion, the third portion forming a living hinge, wherein the living hinge comprises a plurality of indentations such that a majority of the third portion has a third thickness that is less than the first thickness and the second thickness.

In Example 2, the subject matter of Example 1 optionally includes wherein each of the plurality of indentations is arranged parallel to one another.

In Example 3, the subject matter of any one or more of Examples 1-2 optionally include wherein a first subset of the plurality of indentations are arranged parallel to one another and a second subset of the plurality of indentations are arranged perpendicular to the first subset of indentations.

In Example 4, the subject matter of any one or more of Examples 1-3 optionally include wherein a depth of each of the plurality of indentations is the same.

In Example 5, the subject matter of any one or more of Examples 1-4 optionally include wherein a first depth of a first indentation of the plurality of indentations differs from a second depth of a second indentation of the plurality of indentations.

In Example 6, the subject matter of any one or more of Examples 1-5 optionally include wherein each of the plurality of indentations is curved.

In Example 7, the subject matter of any one or more of Examples 1-6 optionally include wherein each of the plurality of indentations is straight.

In Example 8, the subject matter of any one or more of Examples 1-7 optionally include wherein the living hinge forms a curved surface.

In Example 9, the subject matter of any one or more of Examples 1-8 optionally include wherein the living hinge forms a non-planar surface.

In Example 10, the subject matter of Example 9 optionally includes wherein the first portion and the second portion are not coplanar.

Example 11 is a glass article comprising: a glass panel have a first surface and a second surface, the first surface and the second surface defining a thickness of the glass panel; and a plurality of living hinges located on at least one of the first surface or the second surface, wherein each of the plurality of living hinges comprises a plurality of indentations such that an average thickness of the glass panel at each of the plurality of living hinges is less than the thickness of the glass panel.

In Example 12, the subject matter of Example 11 optionally includes wherein a first subset of the plurality of living hinges is located on the first surface and a second subset of the plurality of living hinges is located on the second surface.

In Example 13, the subject matter of any one or more of Examples 11-12 optionally include wherein the average thickness of each of the plurality of living hinges is the same.

In Example 14, the subject matter of any one or more of Examples 11-13 optionally include wherein the average thickness of one of the plurality of living hinges differs from the average thickness of another of the plurality of living hinges.

In Example 15, the subject matter of any one or more of Examples 11-14 optionally include wherein the plurality of indentations for one of the living hinges is curved and the plurality of indentations for another of the living hinges is straight.

Example 16 is a method of forming a glass article, the method comprising: applying a first mask to a first surface of a glass panel, the first mask defining a first plurality of shapes that form a first living hinge; applying an etchant to the first surface of the glass panel to form a first plurality of indentations within the glass panel, each of the first plurality of indentations having one of the first plurality of shapes defined by the first mask and a depth; and bending the glass panel about the first living hinge to form a first curved surface.

In Example 17, the subject matter of Example 16 optionally includes wherein the plurality of shapes includes rectangles arranged parallel to one another.

In Example 18, the subject matter of any one or more of Examples 16-17 optionally include wherein the depths of each of the plurality of indentations is equal.

In Example 19, the subject matter of any one or more of Examples 16-18 optionally include wherein at least one of the depths of one of the plurality of indentations is different than a depth of another of the plurality of indentations.

In Example 20, the subject matter of any one or more of Examples 16-19 optionally include applying a second mask to a second surface of the glass panel, the second mask defining a second plurality of shapes that form second first living hinge, the second surface being located opposite the surface of the glass panel; applying the etchant to the second surface of the glass panel to form a second plurality of indentations within the glass panel, each of the second plurality of indentations having one of the second plurality of shapes defined by the second mask and a depth; and bending the glass panel about the second living hinge to form a second curved surface.

Example 21 is a glass article comprising: a glass layer comprising: a first portion having a first thickness, a second portion having a second thickness, and a third portion disposed in between the first portion and the second portion, the third portion forming a living hinge, wherein the living hinge comprises a plurality of protrusions such that a majority of the third portion has a third thickness that is greater than the first thickness and the second thickness.

In Example 22, the subject matter of Example 21 optionally includes wherein each of the plurality of protrusions is arranged parallel to one another.

In Example 23, the subject matter of any one or more of Examples 21-22 optionally include wherein a first subset of the plurality of protrusions is arranged parallel to one another and a second subset of the plurality of protrusions is arranged perpendicular to the first subset of protrusions.

In Example 24, the subject matter of any one or more of Examples 21-23 optionally include wherein a depth of each of the plurality of protrusions is the same.

In Example 25, the subject matter of any one or more of Examples 21-24 optionally include wherein a first depth of a first protrusion of the plurality of protrusions differs from a second depth of a second protrusion of the plurality of protrusions.

In Example 26, the subject matter of any one or more of Examples 21-25 optionally include wherein each of the plurality of protrusions is curved.

In Example 27, the subject matter of any one or more of Examples 21-26 optionally include wherein each of the plurality of protrusions is straight.

In Example 28, the subject matter of any one or more of Examples 21-27 optionally include wherein the living hinge forms a curved surface.

In Example 29, the subject matter of any one or more of Examples 21-28 optionally include wherein the living hinge forms a non-planar surface.

In Example 30, the subject matter of Example 29 optionally includes wherein the first portion and the second portion are not coplanar.

Example 31 is a glass article comprising: a glass panel have a first surface and a second surface, the first surface and the second surface defining a thickness of the glass panel; and a plurality of living hinges located on at least one of the first surface or the second surface, wherein each of the plurality of living hinges comprises a plurality of protrusions such that an average thickness of the glass panel at each of the plurality of living hinges is greater than the thickness of the glass panel.

In Example 32, the subject matter of Example 31 optionally includes wherein a first subset of the plurality of living hinges is located on the first surface and a second subset of the plurality of living hinges is located on the second surface.

In Example 33, the subject matter of any one or more of Examples 31-32 optionally include wherein the average thickness of each of the plurality of living hinges is the same.

In Example 34, the subject matter of any one or more of Examples 31-33 optionally include wherein the average thickness of one of the plurality of living hinges differs from the average thickness of another of the plurality of living hinges.

In Example 35, the subject matter of any one or more of Examples 31-34 optionally include wherein the plurality of protrusions for one of the living hinges is curved and the plurality of protrusions for another of the living hinges is straight.

Example 36 is a method of forming a glass article, the method comprising: providing a glass panel having a first surface and a second surface; selectively thickening a first portion of the first surface to form a first living hinge such that the first living hinge comprises a first plurality of protrusions extending from the first surface; and bending the glass panel about the first living hinge to form a first curved surface.

In Example 37, the subject matter of Example 36 optionally includes wherein the first plurality of protrusions includes rectangles arranged parallel to one another.

In Example 38, the subject matter of any one or more of Examples 36-37 optionally include wherein a height of each of the first plurality of protrusions is equal.

In Example 39, the subject matter of any one or more of Examples 36-38 optionally include wherein at least one of a height of one of the first plurality of protrusions is different than a height of another of the first plurality of protrusions.

In Example 40, the subject matter of any one or more of Examples 36-39 optionally include selectively thickening a second portion of the second surface to form a second living hinge such that the second living hinge comprises a second plurality of protrusions extending from the second surface; and bending the glass panel about the second living hinge to form a second curved surface.

In Example 41, the articles or methods of any one of or any combination of Examples 1-40 are optionally configured such that all elements or options recited are available to use or select from.

Aspect (1) of this disclosure pertains to a glass article comprising: a glass layer comprising: a first portion having a first thickness, a second portion having a second thickness, and a third portion disposed in between the first portion and the second portion, the third portion forming a living hinge, wherein the living hinge comprises a plurality of indentations such that a majority of the third portion has a third thickness that is less than the first thickness and the second thickness.

Aspect (2) of this disclosure pertains to the glass article of Aspect (1), wherein each of the plurality of indentations is arranged parallel to one another.

Aspect (3) of this disclosure pertains to the glass article of Aspect (1) or Aspect (2), wherein a first subset of the plurality of indentations are arranged parallel to one another and a second subset of the plurality of indentations are arranged perpendicular, or any angle in between, to the first subset of indentations.

Aspect (4) of this disclosure pertains to the glass article of any one of Aspects (1) through Aspect (3), wherein a depth of each of the plurality of indentations is the same.

Aspect (5) of this disclosure pertains to the glass article of any one of Aspects (1) through Aspect (4), wherein a first depth of a first indentation of the plurality of indentations differs from a second depth of a second indentation of the plurality of indentations.

Aspect (6) of this disclosure pertains to the glass article of any one of Aspects (1) through Aspect (5), wherein each of the plurality of indentations is curved.

Aspect (7) of this disclosure pertains to the glass article of any one of Aspects (1) through Aspect (6), wherein each of the plurality of indentations is straight.

Aspect (8) of this disclosure pertains to the glass article of any one of Aspects (1) through Aspect (7), wherein the living hinge forms a curved surface.

Aspect (9) of this disclosure pertains to the glass article of any one of Aspects (1) through Aspect (8), wherein the living hinge forms a non-planar surface.

Aspect (10) of this disclosure pertains to the glass article of Aspect (9), wherein the first portion and the second portion are not coplanar.

Aspect (11) of this disclosure pertains to a glass article comprising: a glass panel having a first surface and a second surface, the first surface and the second surface defining a thickness of the glass panel; and a plurality of living hinges located on at least one of the first surface or the second surface, wherein each of the plurality of living hinges comprises a plurality of indentations such that an average thickness of the glass panel at each of the plurality of living hinges is less than the thickness of the glass panel.

Aspect (12) of this disclosure pertains to the glass article of Aspect (11), wherein a first subset of the plurality of living hinges is located on the first surface and a second subset of the plurality of living hinges is located on the second surface.

Aspect (13) of this disclosure pertains to the glass article of Aspect (11) or Aspect (12), wherein the average thickness of each of the plurality of living hinges is the same.

Aspect (14) of this disclosure pertains to the glass article of any one of Aspects (11) through (13), wherein the average thickness of one of the plurality of living hinges differs from the average thickness of another of the plurality of living hinges.

Aspect (15) of this disclosure pertains to the glass article of any one of Aspects (11) through (14), wherein the plurality of indentations for one of the living hinges is curved and the plurality of indentations for another of the living hinges is straight.

Aspect (16) pertains to a glass article comprising: a glass layer comprising: a first portion having a first thickness, a second portion having a second thickness, and a third portion disposed in between the first portion and the second portion, the third portion forming a living hinge, wherein the living hinge comprises a plurality of protrusions such that a majority of the third portion has a third thickness that is greater than the first thickness and the second thickness.

Aspect (17) pertains to the glass article of Aspect (16), wherein each of the plurality of protrusions is arranged parallel to one another.

Aspect (18) pertains to the glass article of Aspect (16) or Aspect (17), wherein a first subset of the plurality of protrusions is arranged parallel to one another and a second subset of the plurality of protrusions is arranged perpendicular, or any angle in-between, to the first subset of protrusions.

Aspect (19) pertains to the glass article of any one of Aspects (16) through (18), wherein a depth of each of the plurality of protrusions is the same.

Aspect (20) pertains the glass article of any one of Aspects (16) through (19), wherein a first depth of a first protrusion of the plurality of protrusions differs from a second depth of a second protrusion of the plurality of protrusions.

Aspect (21) pertains the glass article of any one of Aspects (16) through (20), wherein each of the plurality of protrusions is curved.

Aspect (22) pertains the glass article of any one of Aspects (16) through (21), wherein each of the plurality of protrusions is straight.

Aspect (23) pertains the glass article of any one of Aspects (16) through (22), wherein the living hinge forms a curved surface.

Aspect (24) pertains the glass article of any one of Aspects (16) through (23), wherein the living hinge forms a non-planar surface.

Aspect (25) pertains the glass article of Aspect (24), wherein the first portion and the second portion are not coplanar.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the embodiments disclosed herein, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

1. A glass article comprising:
a glass layer comprising:
a first portion having a first thickness,
a second portion having a second thickness, and
a third portion disposed in between the first portion and the second portion, the third portion forming a living hinge,
wherein the living hinge comprises a plurality of indentations such that a majority of the third portion has a third thickness that is less than the first thickness and the second thickness.

2. The glass article of claim 1, wherein each of the plurality of indentations is arranged parallel to one another.

3. The glass article of claim 1, wherein a first subset of the plurality of indentations are arranged parallel to one another and a second subset of the plurality of indentations are arranged perpendicular, or any angle in between, to the first subset of indentations.

4. The glass article of claim 1, wherein a depth of each of the plurality of indentations is the same.

5. The glass article of claim 1, wherein a first depth of a first indentation of the plurality of indentations differs from a second depth of a second indentation of the plurality of indentations.

6. The glass article of claim 1, wherein each of the plurality of indentations is curved.

7. The glass article of claim 1, wherein each of the plurality of indentations is straight.

8. (canceled)

9. The glass article of claim 1, wherein the living hinge forms a curved or non-planar surface.

10. The glass article of claim 9, wherein the first portion and the second portion are not coplanar.

11. A glass article comprising:
a glass panel having a first surface and a second surface, the first surface and the second surface defining a thickness of the glass panel; and
a plurality of living hinges located on at least one of the first surface or the second surface,
wherein each of the plurality of living hinges comprises a plurality of indentations such that an average thickness of the glass panel at each of the plurality of living hinges is less than the thickness of the glass panel.

12. The glass article of claim 11, wherein a first subset of the plurality of living hinges is located on the first surface and a second subset of the plurality of living hinges is located on the second surface.

13. (canceled)

14. The glass article of claim 11, one of the plurality of living hinges comprises a first average thickness that differs from a second average thickness of another of the plurality of living hinges.

15. The glass article of claim 11, wherein a first one of the living hinges comprises a plurality of curved indentions and another of the living hinges comprises a plurality straight indentions.

16. A glass article comprising:
a glass layer comprising:
a first portion having a first thickness,
a second portion having a second thickness, and
a third portion disposed in between the first portion and the second portion, the third portion forming a living hinge,
wherein the living hinge comprises a plurality of protrusions such that a majority of the third portion has a third thickness that is greater than the first thickness and the second thickness.

17. The glass article of claim 16, wherein each of the plurality of protrusions is arranged parallel to one another.

18. The glass article of claim 16, wherein a first subset of the plurality of protrusions is arranged parallel to one another and a second subset of the plurality of protrusions is arranged perpendicular, or any angle in-between, to the first subset of protrusions.

19. The glass article of claim 16, wherein a depth of each of the plurality of protrusions is the same.

20. The glass article of claim 16, wherein a first depth of a first protrusion of the plurality of protrusions differs from a second depth of a second protrusion of the plurality of protrusions.

21. The glass article of claim 16, wherein each of the plurality of protrusions is curved.

22. The glass article of claim 16, wherein each of the plurality of protrusions is straight.

23. (canceled)

24. (canceled)

25. (canceled)
